(19) United States
(12) Patent Application Publication
(10) Pub. No.: US 2017/0090066 A1
(43) Pub. Date: Mar. 30, 2017

(54) SYSTEMS AND METHODS FOR ADAPTIVE CANCELLATION OF A MOVING METAL OBJECT'S EFFECT ON RECEIVED SIGNALS

(71) Applicants: Cory Clark, Coral Springs, FL (US); Manuel Soto, Lake Worth, FL (US)

(72) Inventors: Cory Clark, Coral Springs, FL (US); Manuel Soto, Lake Worth, FL (US)

(73) Assignee: Tyco Fire & Security GmbH, Neuhausen Am Rheinfall (CH)

(21) Appl. No.: 15/081,357

(22) Filed: Mar. 25, 2016

Related U.S. Application Data
(60) Provisional application No. 62/233,475, filed on Sep. 28, 2015.

(51) Int. Cl. G01V 13/00; G01V 3/10; G08B 13/24

(52) U.S. Cl. CPC G01V 13/00; G08B 13/248; G01V 3/10

(57) ABSTRACT

Metal detection process includes calibration operations to determine a plurality of gain settings and a plurality of model parameters, each corresponding to a region through which a moving metal door travels as it traverses a predefined motion path. Thereafter, a corresponding one of the plurality of gain settings is selected, and a corresponding set of the model parameters are selected. The selected gain setting control AFE gain so as to maintain the output of the AFE within a predetermined valid operating range. The model parameters are used to cancel the influence of the moving metal door from output controlled AFE signal.

### CROSS-REFERENCE TO RELATED APPLICATIONS

This application claims the benefit of U.S. Patent Provisional No. 62/233,475, filed on Sep. 28, 2015, which is hereby incorporated by reference in its entirety.

### FIELD OF THE INVENTION

This document relates generally to metal detection systems. More particularly, this document relates to systems and methods for adaptive cancellation of a moving metal object's effect on received signals.

### BACKGROUND OF THE INVENTION

Metal detection systems are widely used at entranceways to and from facilities, such as retail stores. The metal detection systems generally detect small fluctuations in a received signal level. The fluctuations are caused by metal objects moving through an interrogation zone in which an electromagnetic field is generated.

One problem that exists with conventional metal detection systems is that a nearby moving metal object (e.g., a metal door) in an environment within or near a metal detection zone can interfere with the detection of smaller metal objects of interest within the interrogation zone. The large nearby moving object in such scenarios can cause large changes in the electromagnetic field gradient, which in turn causes the metal detection system to generate a false alarm. These large changes in the electromagnetic field can also make it difficult to detect target metal objects which the system is designed to detect.

### SUMMARY OF THE INVENTION

The invention concerns a method and system for adaptive cancellation of a moving metal object's effect on received signals in a metal detection system. The method begins with certain calibration operations which involve detecting. Specifically, a system controller of a metal detection system detects an effect or influence of a moving metal object of non interest (“MMONI”) upon on a first signal received at the metal detection system. Thereafter the calibration process continues by determining a plurality of gain settings for an Analog Front End (“AFE”) of receiver circuitry associated with the metal detection system. Each of the gain settings is chosen to correspond to one of a plurality of regions through which the MMONI travels along a predefined motion path. Further, each of the plurality of gain settings is chosen to maintain an output of the AFE within a predetermined valid operating range while moving through each region. After selecting the gain settings, the controller determines a model comprising a set of model parameters to characterize the influence of the moving metal object on the first signal. The model relates a position of the MMONI to predicted received signal amplitude.

Upon completion of the calibration operations, the process continues with certain metal detection operations. These steps involve determining or sensing a MMONI position as it traverses the predefined motion path. Thereafter, for each region through which the MMONI travels a corresponding one of the plurality of gain settings is selected. Further, a corresponding set of the model parameters are selected which are applicable to the region. The selected gain setting for each region are used to control AFE gain so as to maintain the output of the AFE within the predetermined valid operating range and thereby produce a gain controlled AFE output signal. The effects of the moving metal object on the gain controlled signal are then cancelled by applying the model parameters to determine a modeled influence of the MMONI at each door position. The modeled influence of the MMONI is then subtracted from the gain controlled AFE output signal.

### DESCRIPTION OF THE DRAWINGS

Embodiments will be described with reference to the following drawing figures, in which like numerals represent like items throughout the figures, and in which:

FIG. 1 is a schematic illustration of an exemplary Electronic Article Surveillance (“EAS”)/metal detection system with sliding metal doors.

FIG. 2 is a schematic illustration of the EAS/metal detection system shown in FIG. 1 with sliding metal doors in an open configuration.

FIG. 3 is detailed block diagram of electronic components comprising the EAS/metal detection system shown in FIG. 1.

FIGS. 4A-4B (collectively referred to herein as “FIG. 4”) provide a flow diagram of an exemplary method for adaptive cancellation of a moving metal objects effect on received signals.

FIG. 5 is a schematic representation of a predetermined motion path of a MMONI including a plurality of gain control regions through which the MMONI travels.

FIGS. 6A-6D (collectively referred to herein as FIG. 6) are a series of drawings showing a plurality of graphs comprising four cycles of metal doors as they move during a calibration or AFE learning process from a fully closed configuration to a fully open configuration.

FIGS. 7A-7D (collectively referred to herein as FIG. 7) are a series of drawings showing a plurality of graphs comprising a gain controlled received signal after cancellation of certain undesired signal artifacts.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

A metal detection system can be adversely affected by a nearby moving metal object (e.g., a metal door) that is present in an environment within or near a metal detection zone. The large moving metal object, which is actually just part of the operating environment and not of interest with regard to metal detection, can interfere with the primary function of the metal detection system. As is known, the primary function of such systems is the detection of what are typically smaller metal objects which are carried into a detection zone by persons traversing the zone. The large nearby moving object within the operating environment can in such scenarios cause large changes in the electromagnetic field gradient, which in turn causes the metal detection system to generate a false alarm. For convenience, large metal objects of the kind described herein may sometimes be referred to as operating environment moving metal objects of non-interest (MMONI).

One potential solution to the above-stated problem involves storing a pattern that corresponds to a received signal with a nearby MMONI. The stored pattern can then be utilized to remove the effect of the MMONI on subsequent received signal sequences. The stored pattern can then be periodically refreshed when it is determined that “drift” has occurred. But one problem with this solution is that the movement of the MMONI is usually asynchronous to the metal detection sampling intervals. This timing difference causes relatively large variances in the stored pattern over each door cycle, which makes the subsequent cancellation less effective. Another issue involves the Analog Front End (“AFE”) circuitry in the metal detector system. A MMONI that is in or adjacent to a metal detection zone can cause large signal fluctuations in a signal strength of a received metal detection signal and such fluctuations can potentially exceed the dynamic range of an Analog-to-Digital (“A/D”) converter used to convert the detected analog signals to a digital data format.

Embodiments of the inventive arrangements described herein can comprise a metal detection system which includes an adaptive Automatic Level Control (“ALC”) feature, a modeling feature, an effect cancellation feature, and a model update feature. The adaptive ALC feature relates to an automatic gain adjustment of AFE circuitry. The automatic gain adjustment is based on door position. The system learns the gain adjustments to an AFE that are required to keep a received signal that is used for metal detecting from saturating or otherwise exceeding the dynamic range of an A/D converter of a receiver during periods when a MMONI is moving. These gain adjustments are then applied during a metal detection process in accordance with the position of the MMONI (e.g., by adjusting the gain of the AFE by an amount determined based on the nearby metal object's current position). The term “Analog Front End” or “AFE”, as used herein, refers to the analog components between a receive antenna and the A/D converted in receive circuitry. The analog components typically comprise at least a pre-amplifier and an amplifier.

The modeling feature relates to modeling of influence that the MMONI has on a received signal in a metal detection circuit. The effect cancellation feature relates to the utilization of stored modeling parameters to selectively cancel the effect of the nearby MMONI on the received signal. The model update feature relates to an adaptive update of the model parameters to each cycle of the nearby moving metal object. Embodiments of the inventive arrangements as described herein can be used to completely or substantially cancel the negative effect of an MMONI (e.g., a metal sliding door) on a metal detection system.

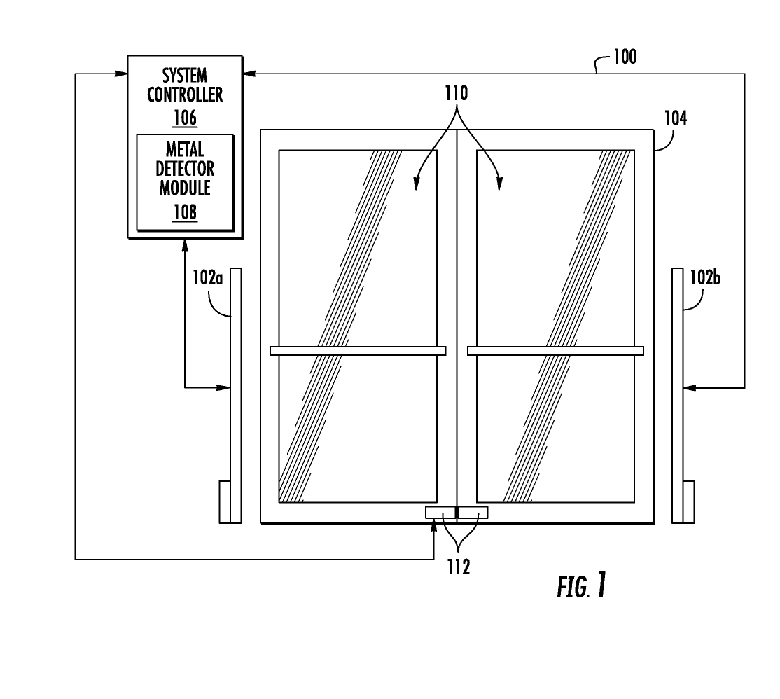

Referring now to FIG. 1, there is a schematic illustration of an EAS/metal detection system 100. Although the present invention is described herein in relation to an EAS/metal detection system. The present invention is not limited in this regard. The present invention is equally adaptable to stand-alone metal detection systems as with integrated EAS/metal detection systems. Thus, the terms “EAS/metal detection system”, “metal detection system” and “detection system” are used interchangeably throughout this specification, and the exclusion of one or the other shall not limit the invention in any way.

An exemplary EAS/metal detection system 100 comprises a pair of pedestals 102a, 102b (collectively referred to herein as “pedestals 102”). The pedestals 102 are typically disposed at an access point of a facility. For example, the pedestals 102a and 102b are located on opposite sides of a doorway 104 so as to be located a known distance apart from each other. At least one antenna for the EAS/metal detection system 100 is included in the pedestals 102a and 102b. The antenna(s) located in the pedestals 102 are electrically coupled to a system controller 106. The system controller 106 controls the operation of the EAS/metal detection system 100.

As shown in FIG. 1, a metal detection module 108 is provided within system controller 106. The metal detection module 108 detects the presence of metal objects within a metal detection region. For example, a metal detection zone can be defined as a three-dimensional space extending between the two pedestals 102a, 102b. Metal detection module 108 detects the presence of metal objects entering or leaving an detection zone established by the antenna(s) between the pedestals 102. The signals used for detecting metal objects herein are sometimes referred to as interrogation signals. These signals are used to generate electromagnetic fields in the area between the two pedestals 102a, 102b for purposes of exciting a response from certain types of objects which are present in the detection zone. Accordingly, the three-dimensional area corresponding to the detection zone as defined between the two pedestals 102a, 102b is also sometimes referred to herein as an interrogation zone.

In some scenarios, the metal detection module 108 is implemented in hardware and/or as software operating on a microprocessor. Additionally or alternatively, the metal detection module 108 comprises a software module stored within a memory of the system controller 106 and/or has an internal processing unit that performs the metal detection functions.

During operation, the metal detection module 108 detects the presence of metal objects within a given metal detection zone. In this regard, the metal detection module 108 includes a transmitter and an antenna collectively configured to transmit metal detection interrogation signals at a specified frequency (e.g., 56 kHz). The transmitter is located on, within, or near the pedestals 102 at an access point of a facility (e.g., a retail store). The transmitter transmits an electromagnetic signal within the specified interrogation zone. The interrogation zone could be, for example, an area of a retail store where metal objects may be brought into or removed therefrom. In the scenario shown in FIG. 1, an exemplary interrogation zone would comprise a three-dimensional zone which extends fully or partially between the first and second pedestal. The transmitter also includes the necessary hardware and software to generate metal detection interrogation signals.

The metal detection module 108 also includes a receiver. The receiver is configured to receive signals generated by and/or transmitted from metal objects located within the interrogation zone. These received signals are generated by metal objects in response to, or as a result of, the interrogation signals from the transmitter antenna. The received signals are forwarded to a processing unit of the metal detection module 108. The processing unit evaluates the received signals to identify those which indicate the presence of metal objects in the interrogation zone. In some scenarios, an alarm associated with such received signals is issued when (a) a characteristic signal value (e.g., an amplitude value) of the received signal is above a given threshold value and/or (b) an induced eddy current is produced during an Electro-Magnetic (“EM”) excitation by an interrogation signal. The induced eddy current dissipates very quickly, on the order of tens of microseconds in the case of a good conductor. The dissipation is slower with a poor conductor. Even with a good conductor, eddy current dissipation is about two orders of magnitude shorter than that of an acoustic marker used in many types of EAS systems. The time differential allows responses from ordinary metal objects which are present in the interrogation zone to be distinguished from responses that are normally associated with EAS marker tags.

As shown in FIG. 1, an exemplary MMONI can comprise two sliding metal doors 110 associated with a doorway 104. Note that the sliding metal doors as described herein can also be at least partially formed of glass, plastic, and/or rubber components. The sliding metal doors 110 open when people, vehicles, animals or objects approach the same. According to one aspect of the invention, one or more sensors are provided to detect a position of each of the sliding metal doors 110 along a defined motion path associated with the opening and closing of such doors. In an exemplary embodiment shown in FIG. 1, at least one door sensor 112 is located on or proximate to the doors 110. Sensors which can be used for this purpose can be comprised of various components which can include, but are not limited to, a contact switch, a magnetic switch, and/or a voltage translator. Other exemplary types of sensors which can be used for this purpose include optical sensors, ultrasonic sensors without limitation. Many different types of position sensors are known and it should therefore be understood that the invention is not limited to any particular type of position sensor. A position sensor as described herein is advantageously capable of producing a position data signal containing information to indicate a door position along a defined motion trajectory. Similarly, in the case of a hinged door, an angular position sensor can be configured to detect an angular position of the door which rotates on a hinge or pivot.

Sliding doors of the type shown in FIG. 1 are commonly motorized and include additional sensors (not shown) which allow them to function automatically. For example, such doors can be configured to automatically open in response to a person approaching the doors, and automatically close after the person passes through the doors. The door sensor 112 is generally configured to detect movement of the doors 110 as they cycle through this opening and closing process. For example, the door sensor 112 detects when the doors 110 are fully open as may occur in response to a person traveling towards the same so as to enter/exit the facility and/or fully closed as may occur when the person is traveling away from the same after entering/exiting the facility. The door sensor 112 is also arranged to sense a plurality of intermediate door positions between the fully open and fully closed positions. In some scenarios, the door sensor can continuously measure door position along a defined door motion path or trajectory.

In some embodiments, an analog output signal from the door sensor 112 can be communicated directly to the system controller 106 and the output of the door sensor(s) can be encoded (e.g. digitally encoded) at the system controller 106. Alternatively, the door sensor can include a data encoder (not shown in FIG. 1) which encodes the door position information prior to such information being communicated to the system controller 106. Any suitable data encoding technique can be used for this purpose. Further, the door sensor 112 can comprise a communication interface (not shown in FIG. 1) which is suitable for formatting the door sensor data for wired or wireless communication to the system controller 106. Such a communication interface can implement any wired or wireless digital data communication protocol now known or known in the future.

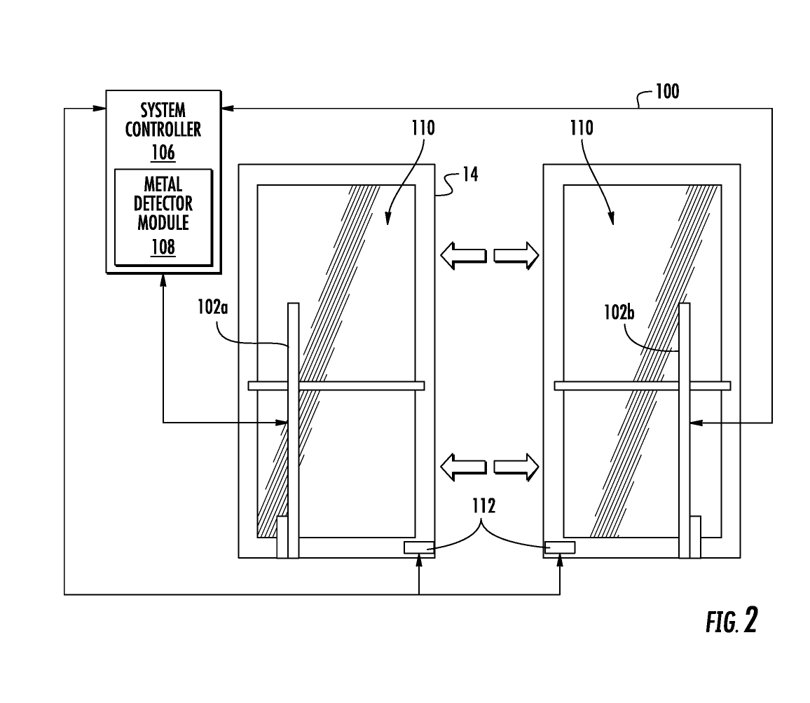

Notably, the door sensor 112 is communicatively coupled to the system controller 106 via a wired or wireless connection. In effect, information can be communicated from the door sensor 112 to the system controller 106 that specifies the detected movement of the doors 110 and/or the current configuration of the doors 110 (e.g., the doors are open 50% or N inches relative to a fully closed position). A closed configuration of the doors 110 is shown in FIG. 1. A partially open configuration of the doors 110 is shown in FIG. 2.

In some scenarios, the door's travel distance along a predefined door motion path is broken down into a plurality of regions for purposes which are described below in further detail. Each region indicates door positions/configurations for which parameters of an AFE should be adjusted during a metal detection process so as to offset and/or compensate for any effect of the door's movement or position on a received signal. The manner in which the AFE parameters will be adjusted is described in detail below. Advantageously, the AFE parameters are dynamically adjusted during a metal detection process based on each of the detected door positions/configurations corresponding to different regions. Accordingly, adjustments to the AFE parameters can be implemented as the door cycles through the various regions between its open and closed configuration.

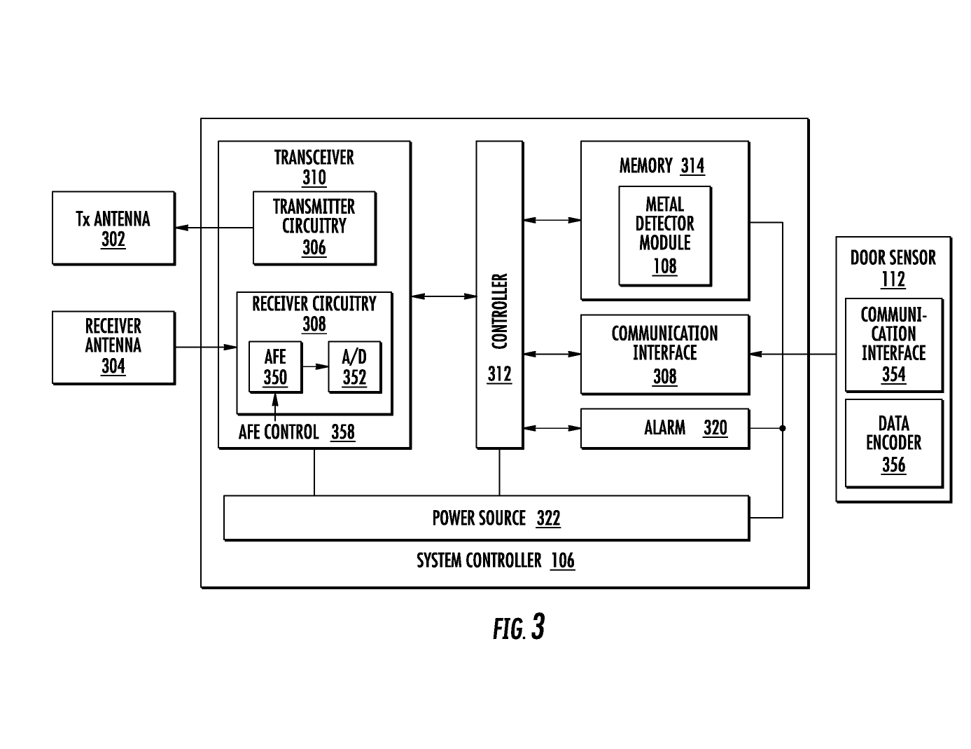

Referring now to FIG. 3, there is provided a detailed block diagram showing the electronic components of the EAS/metal detection system shown in FIGS. 1-2. The electronic components include the system controller 106, at least one transmit antenna 302, at least one receive antenna 304 and door sensor(s) 112. In some scenarios, a single antenna is provided for transmit and receive operations, rather than two antennas. However, for purposes of metal detection as described herein, two separate antennas can sometimes be preferable. For example, a transmit antenna 302 can be located in a first pedestal 102a and a receive antenna 304 can be located in a second pedestal 102b.

The system controller 106 comprises a transceiver 310, a controller 312, memory 314, a communication interface 318, an alarm 320 and a power source 322. The transceiver 310 includes transmitter circuitry 306 and receiver circuitry 308. The transmitter circuitry 306 is generally configured to generate and transmit radio frequency signals which are useful for detecting the presence of metal objects of interest within the metal detection zone defined between the two pedestals 102a, 102b. The transmitter circuitry 306 is electrically coupled to the transmit antenna 304. In some scenarios, the EAS/metal detection system 100 is designed to facilitate the detection of EAS tags in addition to performing metal detection functions. In such systems, the transmitter circuitry 306 can be configured to generate radio frequency signals which are useful for “energizing” EAS markers within the interrogation zone of the EAS/metal detection system 100. The signals used for detecting the presence of metal can be the same signals that are used to excite the EAS tags. However, the invention is not limited in this regard and in some systems, different radio frequency signals can be used for each separate purpose.

The receiver circuitry 308 is generally configured to receive response signals caused by metallic objects which are present in a metal detection zone. Where the system is designed to detect EAS marker tags, the receiver circuitry is likewise configured to receive such response signals from the EAS markers. Accordingly, the receiver circuitry 308 is electrically coupled to the receive antenna 304. The receiver circuitry will include AFE circuitry 350 which receives analog signals from the receiver antenna 304, performs certain processing (e.g. signal amplification, RF filtering) and outputs an analog signal to analog-to-digital (A/D) converter 352. The analog to digital converter converts the incoming analog signal to a digital data format which is in a suitable to facilitate further processing of the signal by controller 312.

Controller 312 is configured to control the operation of transceiver 310 and process digital data output by the A/D 352. The controller 312 also directly or indirectly controls data storage and alarm issuance operations of the system controller 106. The controller 312 can also be configured to perform certain training and modeling functions as hereinafter described. Memory 314 includes a non-volatile memory, a volatile memory, or a combination thereof. In some scenarios, the metal detector module 108 comprises a software module stored in memory 314. In other scenarios, the metal detector module 108 is implemented as discrete components or may be a combination of hardware and software elements. For example, in addition to or instead of controller 312, the system controller 106 can have an internal controller or other processing unit that performs the filtering and metal detection functions described herein.

Communication interface 318 facilitates the exchange of information between the system controller 106 and external devices. For example, the communication interface 318 can facilitate receiving door position data from one or more door sensors 112. In some embodiments, a data encoder 356, which is associated with the door sensor, encodes the door position information prior to such information being communicated to the system controller 106. Further, a communication interface 354 can be provided in association with the door sensor 112. The communication interface 354 can be configured to facilitate communication of the encoded door sensor data in accordance with a digital data communication protocol. The digital data communication protocol can be a wired or wireless communication protocol. During operation, door sensor 112 transmits position information to the system controller 106 where it is utilized by the metal detector module 108. The position information indicates the relative positions/configurations of the doors 110 and/or the exact positions of doors 110 within the door way 104.

Alarm 320 includes software and/or hardware to facilitate the providing of a visual, audible and/or tactile alert in response to the detection of an EAS marker and/or metal object within the detection zone of the EAS/metal detection system 100. The power source 322 supplies power to the electronic components of at least the system controller 106. In this regard, the power source 322 may include, but is not limited to, a battery and/or an Alternating Current (“AC”) power source.

The opening and closing of the doors 110 will cause substantial fluctuations in the EM field emitted into the interrogation zone by the pedestals 102. In this regard, the doors 110 produce different amounts of electromagnetic field gradient disturbance as they gradually move from a fully closed position to a fully open position, and vice versa. The electromagnetic field gradient disturbance causes undesirable effects which can make it difficult to detect low level signals caused by metal objects present within a metal detection/interrogation zone of an EAS/metal detection system. An embodiment which comprises a solution to the problem associated with movement of metal doors in such a scenario involves four basic steps. These steps will be summarized below and then discussed in further detail.

A first step concerns Automatic Level Control of the received signal based on door position. In this step, the system learns a series of adjustments to the AFE 350 that are required to keep the signal from saturating an A/D converter. The adjustments are then applied to the AFE at each of the necessary door positions to ensure that signals provided to the A/D converter are within an acceptable range.

After the AFE adjustments have been applied, a second step involves modeling the influence of the metal door on the received signal in the absence of metal objects which are the target of the detection process. This step will generally involve determining one or more mathematical models which relate a received signal level in the presence of the moving metal door to measured door distance or position along a predetermined motion path. This data is collected to evaluate the effect on the received signal caused by the door alone, exclusive of any other metal objects which might be the target of the metal detection process. An example of a modeling technique as described herein can include linear regression. As is known, linear regression methods can facilitate determination of one or more linear equations which relate a first variable (the received signal levels attributable to the moving door) to a second variable (the measured door distance or position).

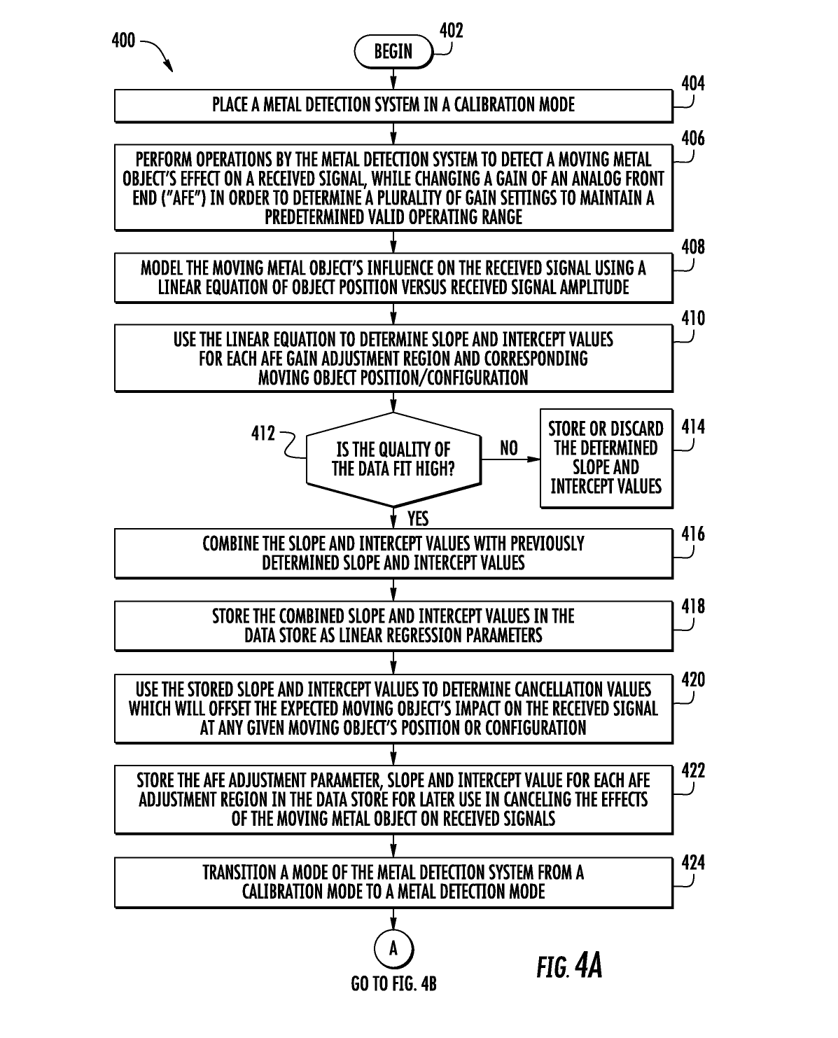

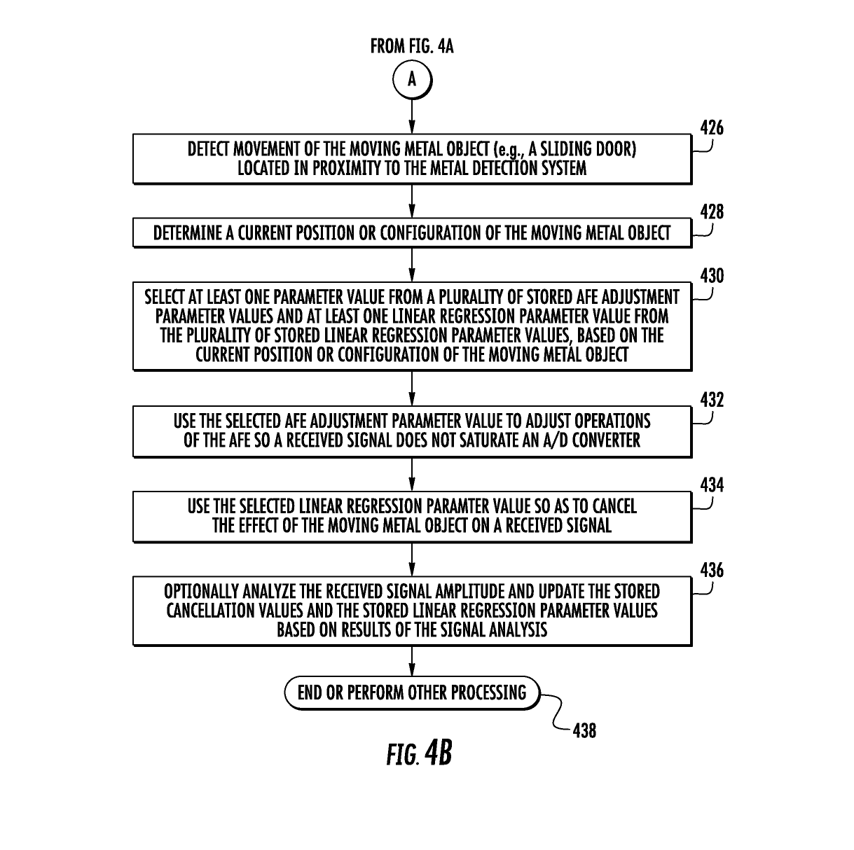

After the model has been created, a third step involves utilizing same to cancel the effect of the moving door on the received signal. More particularly, the mathematical model can be used to determine at each door position a specific received signal level that should be expected in the absence of any extraneous metal objects. Accordingly, an accurate cancellation value can be computed in real time at each measured door position. The specific received signal level value can then be subtracted from a received signal when the metal detection system is active to detect metal objects. The fourth and final step involves adaptively updating the model parameters during each cycle of the door. The four steps will be described below in greater detail with reference to FIGS. 4-7.

Referring now to FIG. 4, there is provided a flow diagram of an exemplary method 400 for adaptive cancellation of a moving metal object's effect on received signals. Method 400 begins with step 402 and continues with step 404 where a metal detection system (e.g., EAS/metal detection system 100 of FIG. 1) is placed in a calibration mode. In the calibration mode, steps 406-422 are performed as hereinafter described. The calibration steps described herein are advantageously performed during a period when the metal detection zone is absent of extraneous metal objects which the system is designed to detect.

Step 406 generally involves performing operations by the metal detection system to detect the effect that a MMONI (e.g., doors 110 of FIG. 1) has upon a received signal at a receiver antenna (e.g. receiver antenna 304). The received signal is detected at the receiver antenna when a transmit signal, which is normally used for metal detection, has been transmitted from a transmit antenna (e.g. transmit antenna 302). The MMONI will cause a perturbation in the electromagnetic field within the metal detection zone and these perturbations will vary greatly as the MMONI travels along its predefined motion path. Consequently, each time a transmitter signal is propagated into the detection zone from the transmit antenna, a signal level of a corresponding received signal detected at the receiver antenna will also vary substantially. These variations will generally occur in a repeatable way as the MMONI moves to each position along its predetermined motion path.

In step 406, the gain of an AFE (e.g. AFE 350) is automatically varied while the metal detection system is in the calibration mode to determine a plurality of AFE gain settings which will maintain the output of the AFE in a predetermined valid operation range as the MMONI moves along the full extent of its predetermined motion path. In some scenarios the valid operating range can be a predetermined or known input voltage range of an A/D converter (e.g. A/D converter 352). In other scenarios, the valid operating range can correspond to a maximum predetermined output voltage range of an analog AFE amplifier (not shown) to prevent saturation.

Referring now to FIG. 5, there is shown a conceptual diagram of a predetermined MMONI motion path 500. For example, the motion path 500 could correspond to a motion path of a sliding metal door. The motion path can include a plurality of regions or sections 504a-504b, within which an MMONI can be present as it moves along the predetermined motion path from a fully closed position at 502a to a fully open position at 502b. Each region or section 504a-504b can include a range of locations or positions where the MMONI may be present along the motion path. For example, at a particular time the MMONI may have a first position 506₁ and at a second time the MMONI may have a second position 506₂. At a third moment in time, the MMONI may have a third position 506₃.

In step 406 a first gain setting can be determined for maintaining an output of the AFE within a valid operating range while the MMONI is within a first range of positions along its predetermined motion path. For example, a first gain setting G(a) can be selected as the MMONI moves through region 504a. But as the MMONI continues to move along its predetermined motion path and approaches region 504b, the output of the AFE may once again be approaching a limit of its valid operating range. Accordingly, a second gain setting G(b) can be determined that will effectively maintain the output of the AFE within the valid operating range as it moves through region 504b. In a similar way, a plurality of additional gain settings G(c)-G(h) can be determined for each of regions 504c-504h.

In FIG. 5, the gain regions are all shown to be of roughly equal length along the motion path 500 of the MMONI. However, it should be understood that the invention is not limited in this regard. The length or distance of a first region 504a over which a particular AFE gain setting is selected need not correspond to a length or distance of a second region 504b over which a second AFE gain setting is determined. Also, it may be noted that eight separate gain setting regions are shown in FIG. 5. However, the invention is not limited with regard to the particular number of regions that are used. Accordingly, more or fewer regions can be used for this purpose without departing from the scope of the present invention.

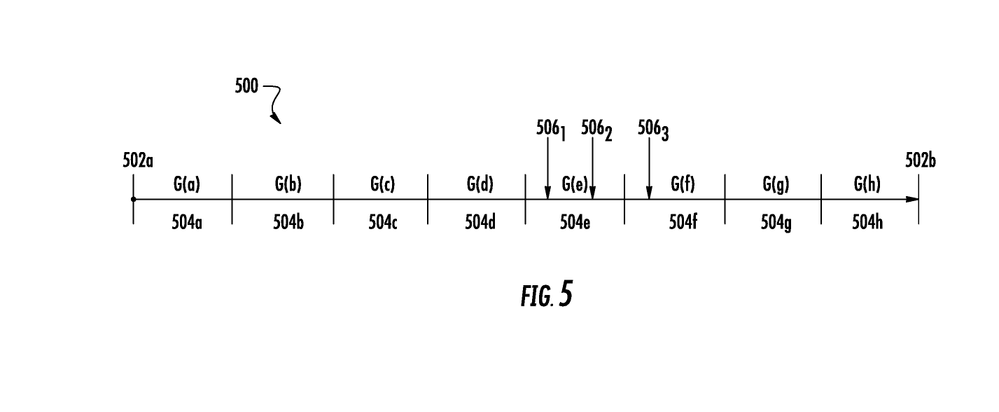

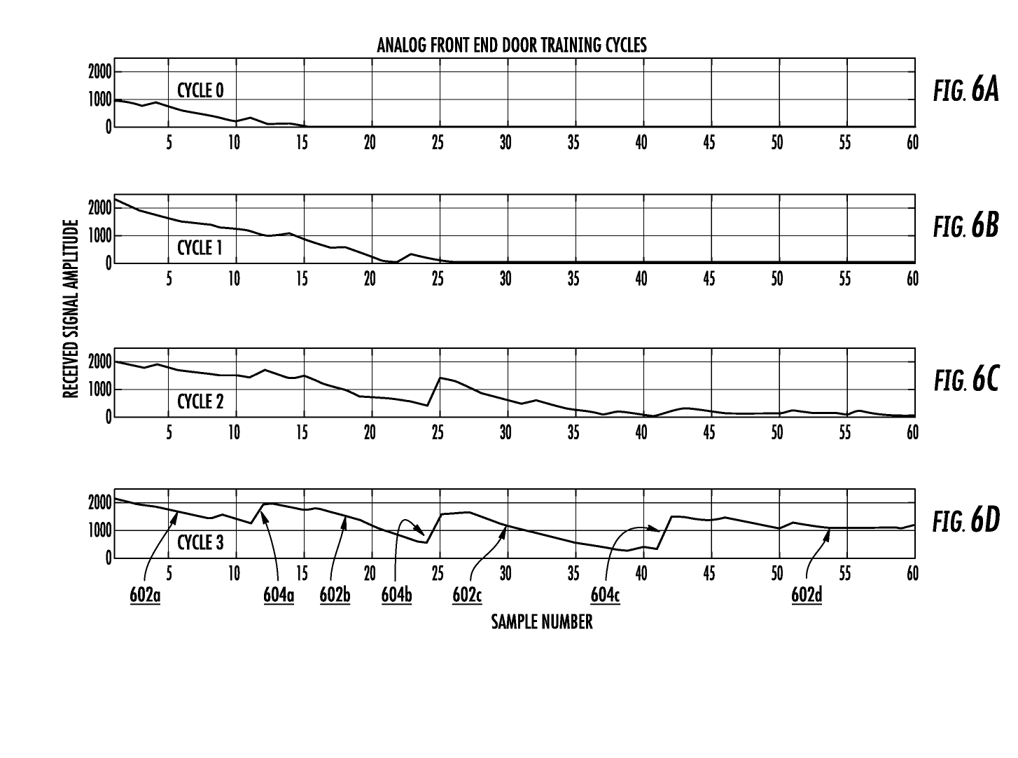

The process described above with respect to step 406 is further illustrated in FIGS. 6A-6D which show a plurality of graphs comprising four cycles of the doors 110 as they move during a calibration or AFE learning process from a fully closed configuration (sample 0) to a fully open configuration (sample 60). Cycle 0 shown in FIG. 6A corresponds to no AFE adjustments during the door movement which results in saturation of the received signal around sample 15. Cycles 1 and 2 which are shown in FIGS. 6B and 6C show the calibration or learning process continuing to adapt the AFE according to the gain required for different door location regions or sections along a predetermined motion path.

As the calibration process progresses, different AFE gain levels are automatically determined for conditions corresponding to when the door is present in various sections or regions along the door motion path. More particularly, in each of FIGS. 6B-6D, the system selectively increases a gain level as the door moves through the various sections or regions of its motion path so as to cause the received signal amplitude to be lifted up off the bottom rail of the A/D converter. Cycle 3 shown in FIG. 6D shows that the AFE training is complete. The resultant received sample sequence looks like a saw tooth waveform as the door opens. The saw tooth is the result of sudden variations in AFE gain which occur as the door transitions through the various regions. For example, in FIG. 6D, it can be observed that the AFE gain is changed at times approximately corresponding to samples 11, 24 41 which correspond to different regions or sections of door travel.

After the AFE gain settings are determined for each of the plurality of regions of the door motion path, the calibration process continues in step 408 wherein the influence or effect of the MMONI upon the received signal is modeled. Any suitable modeling method can be used for the purposes described herein, provided that the resulting model is capable of predicting the received signal amplitude based on each MMONI position or location which is detected or measured along a predetermined motion path. However, it can be observed in FIG. 6D that the resulting saw tooth pattern produced by AFE gain adjustment is comprised of a plurality of portions (e.g., portions 602a, 602b, 602c, 602d) which are each substantially linear and connected by short transition regions 604a, 604b, 604c which are also substantially linear. Accordingly, a simple linear modeling method can be used to model each of the saw tooth portions.

According to one embodiment, the modeling is achieved using a linear regression analysis. The linear regression analysis can be used to determine for each region of MMONI motion a linear equation which relates MMONI position to received signal amplitude. Linear regression is a well-known technique and therefore will not be described here in detail. However, it will be understood that once the linear regression process has been applied, a linear equation can be identified that is fitted to each linear section or region. The linear equations thus identified can then be used in step 410 to determine slope and intercept values for each AFE gain adjustment region and corresponding moving object position/configuration. As is known, a linear equation can be fully characterized in a Cartesian coordinate system based on its slope and intercept values.

In step 412, the quality of the data fit relative to the model is evaluated for each region of MMONI travel. This process can include a comparison of actual received signal data values to those values which are predicted by the model for that region at a plurality of different MMONI positions. A well-fitting model will produce predicted values that are close to the observed received signal data values. A measure of how well the model fits the data can be quantified by determining the root-mean-square error (RMSE). As is known, the RMSE can provide a measure of variance as between the observed data points and the predicted data points. Thereafter, the RMSE can be compared to a threshold which is set in accordance with a minimum acceptable model quality. Of course, other methods can also be used to evaluate the quality of the model without limitation and the method described herein is merely offered as one example.

If the quality of the data fit in a particular region is not sufficiently high [412:NO], then step 414 is performed where the determined slope and intercept values are stored in data store (e.g., memory 314 of FIG. 1) or discarded. In contrast, if the quality of the data fit is high [412:YES], then step 416 is performed where the slope and intercept values determined for the particular region are combined as part of the model with previously determined slope and intercept values for other regions of MMONI position. The combined slope and intercept values for each region are then stored in a data store as linear regression parameters, as shown by step 418. Thereafter, the stored slope and intercept values for each region of MMONI motion are available to determine the AFE adjustment values which will offset the expected impact of the MMONI on the received signals at any given location or position of the MMONI. The AFE adjustment values, slope and intercept for each AFE adjustment region are stored in the data store (e.g. memory 314) for later use in cancelling the effects of the moving metal object on received signals during actual metal detection operations.

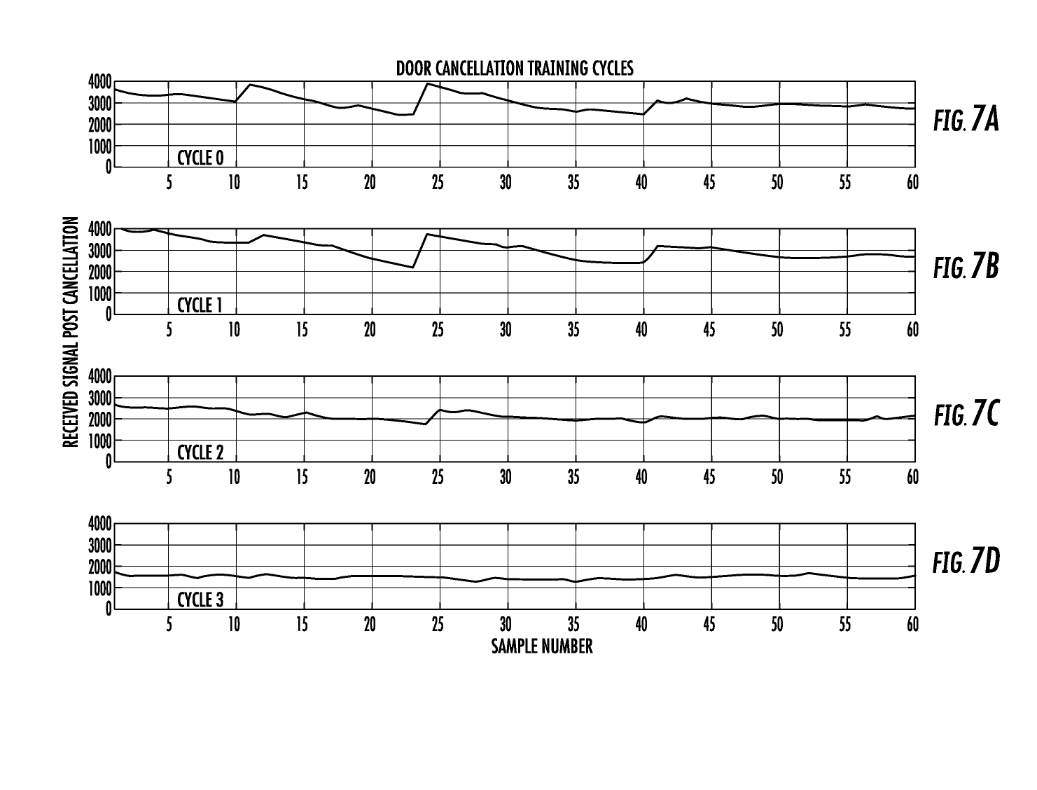

Referring now to FIGS. 7A-7D, there are provided a plurality of graphs showing the model parameter discovery process. These figures also illustrate the improvement obtained over a series of door opening cycles cycle in the ability of the model to cancel the influence of the MMONI. From Cycle 0 to Cycle 3 in FIGS. 7A-7D, a linear regression process is applied to the AFE gain adjusted signal on each cycle of the MMONI. In some scenarios, the process can be applied so as to accumulate the most recently obtained slope and intercept parameters with any existing values for a particular region as may have been obtained from earlier calibration cycles. It can be seen in FIG. 7D, that by Cycle 4, the cancellation parameters can be used to effectively nullify the impact of the MMONI (e.g., sliding metal door) on the AFE gain adjusted received signal. The post-cancellation signal (e.g., the signal shown in FIG. 7D) can be passed to the normal metal detection process. Notably in FIG. 7D, the saw tooth effects of AFE gain adjustment and the influence of the MMONI have been substantially cancelled from the signal.

After the process shown in FIG. 7 is completed, the metal detection system is fully calibrated and ready for subsequent metal detecting operations. Thereafter, by using the AFE gain settings and model parameters determined in the calibration step, detection of very small perturbations in the received signal is facilitated. Minor variations in the received signal caused by metal objects in the detection zone can be more easily detected because the larger variations in signal attributable to the MMONI have been cancelled.

More particularly, upon completing step 422, step 424 is performed where the mode of the metal detection system is transitioned from the calibration mode to a metal detection mode. During the metal detection mode, steps 426-436 of FIG. 4B are performed. These steps involve: detecting movement of the MMONI in proximity to the metal detection system; determining a current position or configuration of the moving metal object; selecting at least one parameter from the plurality of stored AFE adjustment parameters and at least one set of linear regression parameters from the plurality of stored linear regression parameters (i.e., slope and intercept values). The AFE and model parameters are selected based on the current position or configuration of the MMONI. Once selected, the AFE gain adjustment parameter is used to ensure that the received signal output of the AFE is maintained within the predetermined valid operating range. For example, the range can be selected so that the output of the AFE is not saturated and/or does not exceed an input range of an A/D converter. Thereafter, the selected linear regression parameter(s) can be used to cancel the effect of the moving metal object on a received signal. The final step in the process involves optionally analyzing the received signal amplitude during periods when no target metal objects are present in a detection zone and thereafter updating the stored AFE adjustment values and stored linear regression parameter values (i.e., slope and/or intercept values) based on the results of the analysis. In other words, on subsequent door cycles where no metal objects are present in the detection zone, the modeling process (e.g. a linear regression process) is repeated to update the modeling parameters and account for drift. In the case where linear regression is used for this purpose, this step can involve calculate the most recent slope and intercept values to model each region. The most recent slope and intercept values are combined with previous slopes and intercept values to dynamically adapt the stored model parameters to any small changes in the door signature. After completing step 436, step 438 is performed where method 400 ends or other processing is performed.

As noted above, the modeling described herein can be achieved using a linear regression technique. A linear regression model will be the most computationally efficient provided that its assumptions described herein are satisfied (i.e. a linear relationship exists). However, in some scenarios, a linear regression technique may not be sufficient to characterize the relationship between received variations in the metal detection signal caused by the door and the various positions of the door along a defined door movement path. In such scenarios, alternative modeling techniques can be used. For example, in some scenarios where a linear model is insufficient, one may utilize various known correlation techniques to measure and model the association between the two data arrays (i.e. door position versus received metal detection signal). As a further alternative, in scenarios involving non-linear data dispersion, a non-linear curve fitting method can be used to model the effects of the door position on received metal detection signals. This process can involve the use of second or third order polynomial equations. In some scenarios, such higher order equations can more accurately characterize the relationship between door position and the resulting disturbances introduced to the electromagnetic field in the interrogation zone.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for adaptive cancellation of a moving metal object's effect on received signals, comprising:
performing calibration operations comprising
detecting, by a system controller of a metal detection system, an effect of a moving metal object of non interest (MMONI) upon on a first signal received at the metal detection system;
determining a plurality of gain settings for an Analog Front End (“AFE”) of a receiver circuitry associated with the metal detection system, each of said plurality of gain settings corresponding to one of a plurality of regions through which the MMONI travels along a predefined motion path;
selecting each of said plurality of gain settings to maintain an output of the AFE within a predetermined valid operating range while moving through each said region;
after selecting said plurality of gain settings, determining a model comprising a set of model parameters to characterize the influence of the moving metal object on the first signal, said model relating a position of the MMONI to a predicted received signal amplitude; and
following completion of the calibration operations
determining a MMONI position as it traverses the predefined motion path;
selecting for each region through which the MMONI travels a corresponding one of the plurality of gain settings, and a corresponding set of the model parameters applicable to the region;
using the selected gain setting for each region to control AFE gain so as to maintain the output of the AFE within the predetermined valid operating range and thereby produce a gain controlled AFE output signal; and
cancelling the effects of the moving metal object on the gain controlled signal by applying the model parameters to determine a modeled influence of the MMONI at each door position, and subtracting the modeled influence from the gain controlled AFE output signal.

2. The method according to claim 1, further comprising selecting each of the plurality of gain settings to maintain the AFE output within a predetermined input range of an A/D converter to which the AFE is connected.

3. The method according to claim 1, wherein the model is determined using a linear regression method.

4. The method according to claim 1, wherein the model is determined using a non-linear curve fitting method.

5. The method according to claim 1, wherein the MMONI is a moving door comprised of metal.

6. The method according to claim 1, wherein the metal detection system also performs operations to detect one or more electronic article surveillance (EAS) tags.

7. The method according to claim 6, wherein the EAS tags are acouto-magnetic tags.

8. The method according to claim 1, wherein the set of model parameters for each said region facilitates prediction of the gain controlled signal produced in response to the MMONI.

9. The method according to claim 8, wherein the set of model parameters define a linear equation.

10. The method according to claim 9, wherein the model parameters for each said region include a slope value and an intercept value defined in accordance with a Cartesian coordinate system.
